(19) United States
(12) Patent Application Publication
(10) Pub. No.: US 2009/0209657 A1
(43) Pub. Date: Aug. 20, 2009

(54) Soap Kit for Women's Intimate Hygiene and Composition of Soap for the Menstrual Period

(76) Inventor: Luis Eduardo da Cruz, Rio de Janeiro (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/202,566

(22) Filed: Sep. 2, 2008

(30) Foreign Application Priority Data
Feb. 20, 2008 (BR) PI0800156-1

(51) Int. Cl. A61Q 19/10

(52) U.S. Cl. 514/771

(57) ABSTRACT

The present invention refers to a soap kit, preferably liquid, for women's intimate hygiene devised to take into consideration the different phases of the menstrual cycle, keeping the vaginal flora and helping to prevent infection. Besides that, the present invention also refers to a soap composition, preferably liquid, for intimate hygiene, with pH between 3.6 and 4.0 for use during the woman menstrual period. Though the soaps segment in the pharmaceutical market presents a variety of options targeting the woman personal hygiene, these do not take into consideration pH variations seen during the different phases of the menstrual cycle. The objective of the present invention is to provide a kit and a composition of intimate soap for women that can preserve vaginal ecosystem through the different menstrual cycle stages, helping in infection prevention and so reducing chances of irritation processes related to soap not specifically made for this part of the body.

### FIELD OF THE INVENTION

The present invention refers to a soap kit, preferably liquid, for the women's intimate hygiene devised to take into consideration the menstrual cycle period, keeping the vaginal flora and helping to prevent infection. Besides that, the present invention also refers to a soap formulation, preferably liquid, for women's intimate hygiene, with pH between 3.6 and 4.0 for use during the menstrual period. Furthermore, a method for women's intimate hygiene is also provided.

### BACKGROUND OF THE INVENTION

Intimate hygiene represents a fundamental role in the prevention and fight against diseases and should thus be looked upon with special attention, mainly in what concerns the female patient.

As women have internal genital organs, they, in particular, present higher chances of contamination and extra care should be given to their intimate hygiene.

Failure to understand the importance of their hygiene can modify the vaginal environment and favor microorganism proliferation, raising risks of a vaginal infection.

Diverse forms of microorganisms can be found in the vaginal flora and their survival is fundamental in maintain the physiological environment. Many factors, such as temperature changes and oxygenation, may interfere in vaginal ecosystem, although the presence of some of these microorganisms is a key factor in stabilizing the same vaginal ecosystem. Döderlein bacilli, also known as Lactobacillus vaginalis and Lactobacillus acidophilus, is the microorganism predominant in the vaginal flora and the one responsible for the acidity found in this place.

In adult women, who have normal levels of estrogen, vaginal epithelium is pluristratified and the cells have cytoplasm rich in glycogen. With frequent scaling, proper to covering epithelium, glycogen is released and when Döderlein bacilli exists, the glycogen unfolds into more simple substances until lactic acid is produced. This assures a vaginal acidity (between 3.8 and 4.7) and constitutes the genital organ defense barrier, as, to the exception of some fungi, acidity is an enemy of microbial agents.

Children and old women are in general less resistant to infection since their estrogenic function, being deficient, contributes to a less developed vaginal epithelium, low thickness, and consequently with just a few production of glycogen and low acidity.

Vaginal pH ranges at each of the woman's menstrual cycle and life stage and this fact is of great relevance in the diagnostic and treatment of disease.

In girls up to puberty age, vaginal pH varies from 6.8 to 7.2. From puberty to menopause we have the following variations: in the pre-menstrual stage, vaginal pH ranges from 3.8 to 4.2; in the menstrual stage, pH is found to be between 6.8 and 7.2; and, during all the rest of the cycle, pH ranges from 4.0 to 5.0.

Besides the different phases of women's life and their menstrual cycle, other factors can also promote pH changes and consequent vaginal flora unbalance, such as contraceptive hormones, long-term use of antibiotics, diabetes, obesity, pregnancy, the presence of semen, the use of douches for vaginal washing, an excess of cervical mucous and even the psychological status.

When one takes vaginal pH measurement, it is necessary to understand that this measurement will differ from that taken from endocervical or cervical mucous pH, which is between 6.3 to 6.9. This way, some situations as cervical ectropion can lead to an endocervical mucous hyper secretion, which would reduce the vaginal acid degree, situations in which an acidification of the medium would be regarded as desired.

Additionally, semen pH is around 7.2 (ranging from 6.9 to 7.3), which can modify vaginal pH after intercourse for approximately 10 hours.

Changes to vaginal pH, whether because of its acidity or alkalinity, can favor contamination and vagina colonization. Both the american Center for Disease Control and Prevention (CDC), and the American College of Obstetricians and Gynecologists recommend that diagnosis of vaginitis should be made through a fresh exam of the vaginal secretion and measurement of vaginal pH. Based on pH measure, the cases can be divided into two basic categories: normal/candidiasis, in cases where pH is found to be normal, and bacterial vaginosis/trichomaniasis, in case the pH is higher than normal. Pavletic et al. assessed 203 patients and observed that routine testing of pH significantly increased the detection of trichomoniasis and bacterial vaginosis cases in asymptomatic patients.

pH versus Disease

Vaginal pH is distinct not only in the variety of feminine life circumstances, but also in what regards the phases of their menstrual cycle. Vaginal pH changes, both in relation to their raise and in relation to their decrease, can favor vaginal infection and colonization.

Vaginal pH routine measurement has been prescribed even as to diagnose certain vaginal infections.

Vaginitis, infectious or not, constitute a major cause of illnesses and one of the most frequent reasons of appointments with gynecologists and obstetricians.

Vaginitis common infection forms include bacterial vaginosis, trichomoniasis and vulvovaginal candidiasis.

In patients with bacterial vaginosis there is a substitution of the vaginal flora, usually dominated by the lactobacilli, by an abundant bacterial flora of strict or facultative anaerobes (Gardnerella vaginalis, Mycoplasma hominis, and anaerobic including Mobiluncus, Bacterioides Peptostreptococcus spp.). The main symptom of bacterial vaginosis is the presence of a fluid grayish or yellowish secretion and with an unpleasant odor.

The diagnosis is primarily based in Amsel's criteria (milky and homogenous secretion, pH higher than 4.5, amine positive test with 10% KOH, presence of target cells, positive for Whiff's test). There are asymptomatic cases of bacterial vaginosis, which can be suspected from alterations noticed in pH measurements, and that should be treated in pregnant women, thus preventing abortions and premature deliveries.

Vaginitis caused by Trichomonas vaginalis is characterized by a yellowish-greenish vaginal discharge, irritability and pain in the vulva, dyspareunia and dysuria. The trichomoniasis asymptomatic cases should be treated and can also be detected by measuring the pH.

Finally, vulvovaginal candidiasis is one of the most common causes of vaginitis. Its symptoms are leucorrhea (a whitish flow), intense itching, dyspareunia (pain felt when having sexual intercourse), vulvar hyperemia and dysuria. Many predisposing factors are associated to vulvovaginal candiadiasis, such as pregnancy, diabetes mellitus, use of hormonal contraceptives, hormone reposition therapies, antibiotics, immunosuppressant diseases, amongst others.

Determining the vaginal pH helps diagnosing vaginitis, high pH (5.0 to 6.0) suggesting Trichomonas vaginalis or bacterial vaginosis (Gardnerella vaginalis; pH 5.0) and vulvovaginal candidiasis is generally detected in the normal vagina pH (<4.7).

Prevention of vaginal pH changes, perineum vulvovaginal diseases and infections of the lower genital tract can be obtained through good personal hygiene habits, use of adequate clothes, avoiding douches for vaginal washing (which “drain” normal flora away) and by regular appointments with the gynecologist. Through medical evaluation, other predisposing factors to vaginal infections can be controlled, such as diabetes mellitus and obesity.

### Ordinary Soap Compared to the Personal Soap

Hygiene comprises all habits and ways to prevent diseases, keep healthy and in well-being of the subjects. Lack of attention towards intimate hygiene can bring serious damage to the organism, since woman sexual organs are peculiarly anatomic areas and require special hygiene care.

The use of ordinary soaps which have alkaline pH is inadequate for their potential to trigger dermatitis due to primary irritation, in a naturally more sensitive area. This dermatitis can evolve causing stressing discomfort generating redness (erythema), itching and/or burning.

Ordinary soaps can not only contribute to irritation dermatitis but also due to their own high pH, raise the vaginal pH and in this way ease some infectious processes.

At present there are some soaps in the market searching for a more fitting pH specificity towards women's intimate hygiene, such as Dermacyd® from Sanofi-Aventis and Lucretin®, from Farmasa. However these products do not take into account the different changes in the woman's menstrual cycle, treating their genital organ as if its pH was constant.

The objective of the present invention is to show respect for pH changes in the menstrual phase when related to the other phases of the rest of the cycle, helping in the prevention of infection while at the same time reducing the irritation processes and bringing more comfort to the woman.

### SUMMARY OF THE INVENTION

The present invention refers to the production of two soap formulations, preferably liquid, that are basically differentiated by their pH value, and which are recommended for women's intimate hygiene in distinct phases of their menstrual cycle.

Formulation I presents pH between 3.6 and 4.0 and is recommended for the menstrual cycle (average duration of 3 to 5 days). At this stage, vaginal pH oscillates between 6.8 and 7.2 (practically neutral) and the use of a product able to acidify the medium will help in restoring the vagina's physiological pH (between 4.0 and 5.0) and contribute to the prevention of some diseases which tend to develop in a more alkaline pH.

Formulation II presents pH ranging from 4.3 to 4.7 and is recommended to the remaining days in the menstrual cycle (average duration of 25 to 27 days). The product's pH being similar to the physiological pH will contribute to the maintenance of vaginal flora.

Both formulations can be presented together in the same package containing two flasks disposed together, the first containing, preferably, of 50-200 mL of formulation I and the second containing from 100-400 mL of formulation II.

### DETAILED DESCRIPTION OF THE INVENTION

The present invention is based on the concept of devising and formulating a soap kit containing two soap formulations, preferably liquid, basically differentiated by their pH values and recommended for women's intimate hygiene use on their different menstrual cycle stages.

Formulation I presents pH ranging from 3.6 to 4.0 and is recommended for use during the menstrual period (average duration from 3 to 5 days) and contributes to the prevention of some diseases which tend to develop in a more alkaline pH.

Formulation II presents pH ranging from 4.3 and 4.7 and is recommended for all other days of the cycle (average duration from 25 to 27 days). The product pH being similar to the physiological pH will contribute to keep the vaginal flora working well.

Both formulations have been tested and received official reports of “Hyper allergenic products and products gynecologically tested”.

Formulations I and II of the soap comprise: viscosity controlling, surfactant, pH adjuster and a cosmetically acceptable carrier.

The chosen viscosity regulator should preferably be a carbomer and in particular the Carbopol Ultrez 20®.

The selected surfactant substance must come from the group composed of anionic surfactant, non-anionic surfactant and their mixes. The surfactant agent must particularly be chosen from sodium laureth sulfate, sodium laureth sulfosuccinate, sodium cocoyl glutamate, decyl polyglucose, lauryl polyglucose, diethanolamine of coconut fatty acid (cocamide DEA) and monoethanolamine of coconut fatty acid.

Preferably, formulations I and II comprise at least a pH adjuster selected from acid pH adjuster, preferably of lactic acid, citric acid or a mix of both, and a base pH adjuster, preferably sodium hydroxide.

Preferably, the cosmetically acceptable carrier is preferably water.

Formulations I and II of the soap can also comprise humectants and emollients such as etoxylated lanolin (PEG-75 lanolin), ethoxylated almond oil and glycerin, preservatives, such as Phenova® (a mix of phenoxyethanol and parabens) and imidazolinidyl urea, colorants, essences, perfumes, fragrances, flavoring agents and antimicrobial agents.

The present invention also refers to a soap composition, preferably liquid, for women's intimate hygiene with pH ranging from 3.6 to 4.0 for use during the menstrual cycle. Such soap composition comprises in its formula the ingredients used for the kit soap of the present invention.

The preparation of formulation I and II of the kit of the present invention and soap composition with pH between 3.6 to 4.0 pH of the present invention should follow the stages below:

1) Preparation of phase 1: Disperse the viscosity regulator, preferably a carbomer, particularly Carbopol Ultrez 20®, into a cosmetically acceptable carrier, preferably water, in temperature approximately of 30 to 50° C., preferably around 40° C., softly stirring it. Following that, add a basic pH adjuster, preferably a sodium hydroxide, until a gel is formed;

2) Preparation of phase 2: In a different vessel, mix the other components until a homogeneous mix is reached;

3) Mix phases 1 and 2 and homogenize again;

4) Add an acid pH adjuster, preferably lactic or citric acid until the desired pH is reached, under agitation.

In addition, the present invention also refers to a method for women's intimate hygiene comprising to apply a composition or a kit of the present invention in the external genital organ of a woman.

### FEATURES OF THE PRESENT INVENTION

The present invention is characterized by the perception that the modern woman is demanding and dynamic and requires differentiated products for her personal care. To understand the complexity of the woman's body with its hormone alterations and the changes that these alterations bring should be a premise for the pharmaceutical and cosmetics industries. The kit with two intimate hygiene soaps with different pH levels according to the present invention has an innovative approach in comparison to its counterparts now in the market, since its formulations are adapted to women's needs in each part of the menstrual cycle.

Besides, according to the present invention, the soap composition, preferably liquid, for women's intimate hygiene with pH ranging from 3.6 to 4.0 for use during the menstrual period is useful in the prevention of diseases which tend to develop under a more alkaline pH and, therefore, an advanced choice when compared to other women state of the technique soaps for intimate use.

### BEST MODE FOR CARRYING OUT THE INVENTION

Detailed illustrative embodiments of the invention disclosed herein exemplify the invention and are currently considered to be the best embodiments for such purposes. They are provided by way of illustration and not limitation of the invention. Various modifications thereof will occur to those skilled in the art, and such modifications are within the scope of the claims which define the present invention.

The best modes for carrying out the present invention are:

a) A soap composition for intimate hygiene having a pH between 3.6 and 4.0, in the liquid form, comprising 0.30% by weight of Carbopol Ultrez 20® as viscosity regulator, 1 to 42% by weight of sodium laureth sulfate, sodium laureth sulfosuccinate, sodium cocoyl glutamate, decyl polyglucose, lauryl polyglucose, coconut fatty acid diethanolamine (cocamide DEA) or coconut fatty acid monoethanolamine as surfactant, 3% by weight of lactic acid, citric acid or mixtures thereof as acid pH adjuster, 0.05% by weight of sodium hydroxide as basic pH adjuster and water;

b) A kit comprising a) a soap with pH ranging from 3.6 to 4.0 for use during the menstrual period; and b) a soap with pH ranging from 4.3 to 4.7 for use in the remaining days of the menstrual cycle comprising 0.30% by weight of Carbopol Ultrez 20® as regulator viscosity, 1 to 42% by weight of sodium laureth sulfate, sodium laureth sulfosuccinate, sodium cocoyl glutamate, decyl polyglucose, lauryl polyglucose, coconut fatty acid diethanolamine (cocamide DEA) or coconut fatty acid monoethanolamine as surfactant, 3% by weight of lactic acid, citric acid or mixtures thereof as acid pH adjuster of soap a), 1.70% by weight of lactic acid, citric acid or mixtures thereof as acid pH adjuster of soap b), 0.05% by weight of sodium hydroxide as basic pH adjuster and water; and

c) A method for women's intimate hygiene comprising to apply a composition or a kit of the present invention in the external genital organ of a woman.

### EXAMPLES

The following examples are best variations for kit and composition of the soaps for menstrual period according to the present invention and should not be taken as limitations to the invention. Therein, it should be understood that the scope of the present invention allows for other possible variations, being limited only by the claims hereby shown, all possible equivalent included.

Soap compositions in Examples 1 to 3 below were made according to the process already described above.

### Example 1

Kit of liquid soap for women's intimate hygiene containing:
Formulation I with pH ranging from 3.6 to 4.0—recommended for use during the menstrual phase (average duration of 3 to 5 days);
Formulation II with pH ranging from 4.3 to 4.7—recommended for use during the other days of the menstrual cycle (average duration of 25 to 27 days).

### Formulation I:

| | Preferential | Special | |
|---|---|---|---|
| | Concentration | Concentration | |
| Raw Materials | (% w/w) | (% w/w) | Properties |
| Carbopol Ultrez 20 ® | 0.20-0.80 | 0.30 | Gel forming, viscosity |
| | | | regulator. |
| Sodium Laureth Sulfate | 10.00-25.00 | 12.00 | Surfactant, anionic |
| | | | surfactant, detergent |
| | | | and foam promoters |
| Sodium Glutamate Cocoyl | 1.00-5.00 | 3.00 | Surfactant, light |
| | | | anionic surfactant. |
| Decyl Polyglucose | 1.00-5.00 | 4.00 | Surfactant, non- |
| | | | anionic surfactant. |
| Coconut Fatty Acid | 2.00-7.00 | 6.00 | Surfactant, non- |
| Diethanolamine | | | anionic surfactant, |
| | | | viscosity regulator, re- |
| | | | fating. |
| Ethoxylated Lanolin | 0.500-3.00 | 2.00 | Emollient |
| Glycerin | 2.00-11.00 | 10.00 | Humectant, emollient |
| Phenova ® | 0.15-0.80 | 0.50 | Preservative |
| Lactic Acid | 2.50-3.20 | 3.00 | pH adjuster |
| Sodium Hydroxide | 0.01-0.06 | 0.05 | pH adjuster |
| Essence | 0-0.5 | 0.15 | Essence |
| Water | q.s.p 100 | q.s.p 100 | carrier |

### Formulation II:

| | Preferential | Special | |
|---|---|---|---|
| | Concentration | Concentration | |
| Raw Materials | (% w/w) | (% w/w) | Properties |
| Carbopol Ultrez 20 ® | 0.20-0.80 | 0.30 | Gel forming, viscosity |
| | | | regulator. |
| Sodium Laureth Sulfate | 10.00-25.00 | 12.00 | Surfactant, anionic |
| | | | surfactant, detergent |
| | | | and foam promoters |
| Sodium Cocoyl Glutamate | 1.00-5.00 | 3.00 | Surfactant, light |
| | | | anionic surfactant |
| Decyl Polyglucose | 1.00-5.00 | 4.00 | Surfactant, non- |
| | | | anionic surfactant. |
| Coconut Fatty Acid | 2.00-7.00 | 6.00 | Surfactant, non- |
| Diethanolamine | | | anionic surfactant, |
| | | | viscosity regulator, re- |
| | | | fating. |
| Ethoxylated Lanolin | 0.500-3.00 | 2.00 | Emollient |
| Glycerin | 2.00-11.00 | 10.00 | Humectant, emollient |
| Phenova ® | 0.15-0.80 | 0.50 | Preservative |
| Lactic Acid | 1.50-2.00 | 1.70 | pH adjuster |
| Sodium Hydroxide | 0.01-0.06 | 0.05 | pH adjuster |
| Essence | 0-0.5 | 0.15 | Essence |
| Water | q.s.p 100 | q.s.p 100 | Carrier |

### Example 2

Kit of liquid soap for women's intimate hygiene containing:
Formulation I with pH ranging from 3.6 to 4.0—recommended for use during the menstrual period (average duration of 3 to 5 days)
Formulation II with pH ranging from 4.3 to 4.7—recommended for use during the remaining days of the menstrual cycle ( average duration of 25 to 27 days)

### Formulation I:

| | Preferential | Special | |
|---|---|---|---|
| | Concentration | Concentration | |
| Raw Materials | (% w/w) | (% p/p) | Properties |
| Carbopol Ultrez 20 ® | 0.20-0.80 | 0.30 | Gel forming, viscosity |
| | | | regulator. |
| Sodium Laureth Sulfate | 10.00-25.00 | 12.00 | Surfactant, anionic |
| | | | surfactant, detergent |
| | | | and foam agents |
| Sodium Cocoyl Glutamate | 1.00-5.00 | 3.00 | Surfactant, light |
| | | | anionic surfactant. |
| Lauryl Polyglucose | 1.00-5.00 | 4.00 | Surfactant, non- |
| | | | anionic surfactant. |
| Coconut Fatty Acid | 2.00-7.00 | 6.00 | Surfactant, non- |
| Monoethanolamine | | | anionic surfactant, |
| | | | viscosity regulator, re- |
| | | | fating. |
| Etoxylated Almond Oil | 0.500-3.00 | 2.00 | Emollient |
| Glycerin | 2.00-11.00 | 10.00 | Humectant, emollient |
| Imidazolinidyl Urea | 0.20-0.70 | 0.60 | Preservative |
| Citric Acid | 2.50-3.20 | 3.00 | pH adjuster |
| Sodium Hydroxide | 0.01-0.06 | 0.05 | pH adjuster. |
| Essence | 0-0.5 | 0.15 | Essence |
| Water | q.s.p 100 | q.s.p 100 | Carrier |

### Formulation II:

| | Preferential | Special | |
|---|---|---|---|
| | Concentration | Concentration | |
| Raw Materials | (% p/p) | (% p/p) | Properties |
| Carbopol Ultrez 20 ® | 0.20-0.80 | 0.30 | Gel forming, viscosity |
| | | | regulator. |
| Sodium Laureth Sulfate | 10.00-25.00 | 12.00 | Surfactant, anionic |
| | | | surfactant, detergent |
| | | | and foam promoter. |
| Sodium Cocoyl Glutamate | 1.00-5.00 | 3.00 | Surfactant, light |
| | | | anionic surfactant. |
| Lauryl Polyglucose | 1.00-5.00 | 4.00 | Surfactant, non- |
| | | | anionic surfactant. |
| Coconut Fatty Acid | 2.00-7.00 | 6.00 | Surfactant, non- |
| Monoethanolamine | | | anionic surfactant, |
| | | | viscosity regulator, re- |
| | | | fating. |
| Etoxylated Almond Oil | 0.500-3.00 | 2.00 | Emollient |
| Glycerin | 2.00-11.00 | 10.00 | Humectant, emollient |
| Imidazolinidyl Urea | 0.20-0.70 | 0.60 | Preservative |
| Citric Acid | 1.50-2.00 | 1.70 | pH adjuster |
| Sodium Hydroxide | 0.01-0.06 | 0.05 | pH adjuster |
| Essence | 0-0.5 | 0.15 | Essence |
| Water | q.s.p 100 | q.s.p 100 | Carrier |

### Example 3

Composition of liquid soap for women's intimate hygiene with pH ranging from 3.6 to 4.0 for use during the menstrual period (average duration from 3 to 5 days).

### Option 1:

| | Preferential | Special | |
|---|---|---|---|
| | Concentration | Concentration | |
| Raw Materials | (% w/w) | (% p/p) | Properties |
| Carbopol Ultrez 20 ® | 0.20-0.80 | 0.30 | Gel forming, viscosity |
| | | | regulator. |
| Sodium Laureth Sulfate | 10.00-25.00 | 12.00 | Surfactant, anionic |
| | | | surfactant, detergent |
| | | | and foam promoters. |
| Sodium Cocoyl Glutamate | 1.00-5.00 | 3.00 | Surfactant, light |
| | | | anionic surfactant. |
| Decyl Polyglucose | 1.00-5.00 | 4.00 | Surfactant, non- |
| | | | anionic surfactant. |
| Coconut Fatty Acid | 2.00-7.00 | 6.00 | Surfactant, non- |
| Diethanolamine | | | anionic surfactant, |
| | | | viscosity regulator, re- |
| | | | fating. |
| Etoxylated lanolin | 0.500-3.00 | 2.00 | Emollient |
| Glycerin | 2.00-11.00 | 10.00 | Humectant, emollient |
| Phenova ® | 0.15-0.80 | 0.50 | Preservative |
| Lactic Acid | 2.50-3.20 | 3.00 | pH adjuster |
| Sodium Hydroxide | 0.01-0.06 | 0.05 | pH adjuster |
| Essence | 0-0.5 | 0.15 | Essence |
| Water | q.s.p 100 | q.s.p 100 | Carrier |

### Option 2:

| | Preferential | Special | |
|---|---|---|---|
| | Concentration | Concentration | |
| Raw Materials | (% p/p) | (% p/p) | Properties |
| Carbopol Ultrez 20 ® | 0.20-0.80 | 0.30 | Gel forming, viscosity |
| | | | regulator. |
| Sodium Laureth Sulfate | 10.00-25.00 | 12.00 | Surfactant, anionic |
| | | | surfactant, detergent |
| | | | and foam promoters |
| Sodium Cocoyl Glutamate | 1.00-5.00 | 3.00 | Surfactant, light |
| | | | anionic surfactant |
| Lauryl Polyglucose | 1.00-5.00 | 4.00 | Surfactant, non- |
| | | | anionic surfactant. |
| Coconut Fatty Acid | 2.00-7.00 | 6.00 | Surfactant, non- |
| Monoethanolamine | | | anionic surfactant, |
| | | | viscosity regulator, re- |
| | | | fatting. |
| Etoxylated Almond Oil | 0.500-3.00 | 2.00 | Emollient |
| Glycerin | 2.00-11.00 | 10.00 | Humectant, emollient |
| Imidazolinidyl Urea | 0.20-0.70 | 0.60 | Preservative |
| Citric Acid | 2.50-3.20 | 3.00 | pH adjuster. |
| Sodium Hydroxide | 0.01-0.06 | 0.05 | pH adjuster |
| Essence | 0-0.5 | 0.15 | Essence |
| Water | q.s.p 100 | q.s.p 100 | Carrier |

Liquid soap compositions according to the present invention were submitted to the analysis of its potential of primary dermal irritability, accumulated dermal irritability, allergenic potential, photo irritant and photosensitive potential risk after a series of topical applications in humans.

All results obtained were satisfactory. Compositions showed good skin compatibility levels after one application and after repeated applications on the volunteers assessed. No allergic reaction was detected in the volunteers assessed. It was also verified the absence of photo irritant and photosensitivity potential risks of liquid soap compositions of the present invention caused.

Therefore, the compositions of the present invention received the official report of “Hyper allergenic products and gynecologically tested”.

1. Soap kit for women's intimate hygiene, characterized by comprising:
a) a soap with pH ranging from 3.6 to 4.0 for use during the menstrual period; and
b) a soap with pH ranging from 4.3 to 4.7 for use in the remaining days of the menstrual cycle.

2. Kit according to claim 1, characterized in that the soaps a) and b) are liquid.

3. Kit according to claim 2, characterized in that the soaps a) and b) comprise viscosity regulator, surfactant, pH adjuster and cosmetically acceptable carrier.

4. Kit according to claim 3, characterized in that the viscosity regulator is a carbomer.

5. Kit according to claim 3, characterized in that the viscosity regulator is present in an amount ranging from 0.20 to 0.80% by weight.

6. Kit according to claim 3, characterized in that the soaps a) and b) comprise at least one surfactant selected from the group of anionic surfactant, non-anionic surfactant and mixtures thereof.

7. Kit according to claim 6 wherein the at least one surfactant chosen from sodium laureth sulfate, sodium laureth sulfosuccinate, sodium cocoyl glutamate, decyl polyglucose, lauryl polyglucose, coconut fatty acid diethanolamine (cocamide DEA) and coconut fatty acid monoethanolamine.

8. Kit according to claim 6, characterized in that the at least one surfactant is present in an amount ranging from 1.00 to 42.00% by weight.

9. Kit according to claim 3, characterized in that the soaps a) and b) comprise at least one pH adjuster comprises an acid pH adjusters selected from the group consisting of lactic acid, citric acid and mixtures thereof, or selected from the group of sodium hydroxide.

10. Kit according to claim 9, characterized in that the acid pH adjuster of soap a) is present in an amount of 2.50 to 3.20% by weight.

11. Kit according to claim 9, characterized in that the acid pH adjuster of soap b) is present in an amount ranging from 1.50 to 2.00% by weight.

12. Kit according to claim 9, characterized in that the basic pH adjuster is present in an amount ranging from 0.01 to 0.06% by weight.

13. Kit according to claim 3, characterized in that the cosmetically acceptable carrier is water.

14. Kit according to claim 3, characterized in that the soaps a) and b) further comprise ingredients selected from the group consisting of humectants; emollients, such as etoxylated lanolin (PEG-75 lanolin), etoxylated almond oil and glycerin; preservatives colorants, perfumes; fragrances; aromatizing agents and antimicrobial agents.

15. Soap composition for women's intimate hygiene, characterized in that it presents a pH ranging from 3.6 to 4.0 for use during the menstrual period.

16. Soap composition according to claim 15, characterized in that it is liquid.

17. Soap composition according to claim 15, characterized in that it contains viscosity regulator, surfactants, pH adjuster and a cosmetically acceptable carrier.

18. Soap composition according to claim 17, characterized in that the viscosity regulator is a carbomer.

19. Soap composition according to claim 17, characterized in that the viscosity regulator is present in an amount ranging from 0.20% to 0.80% by weight.

20. Soap composition according to claim 17, characterized by comprising at least one surfactant selected from the group consisting of anionic surfactants, non-anionic surfactants and mixtures thereof.

21. Kit according to claim 20, wherein the at least one surfactant from the group consisting of sodium laureth sulfate, sodium laureth sulfosuccinate, sodium cocoyl glutamate, decyl polyglucose, lauryl polyglucose, coconut fatty acid diethanolamine (cocamide DEA) and coconut fatty acid monoethanolamine.

22. Soap composition according to claim 20, characterized in that the at least one surfactant is present in an amount ranging from 1.00% to 42.00% by weight.

23. Soap composition according to claim 17, characterized by comprising at least one pH adjuster comprises an acid pH adjuster, selected from the group consisting of lactic acid, citric acid and mixtures thereof, or selected from the group consisting of sodium hydroxide.

24. Soap composition according to claim 23, characterized in that the acid pH adjuster is present in an amount ranging from 2.50% to 3.20% by weight.

25. Soap composition according to claim 23, characterized in that the basic pH adjuster is present in an amount ranging from 0.01% to 0.06% by weight.

26. Soap composition according to claim 17, characterized in that the cosmetically acceptable carrier is water.

27. Soap composition according to claim 17, characterized by further comprising ingredients selected from the group consisting of humectants; emollients, such as etoxylated lanolin (PEG-75 lanolin), etoxylated almond oil and glycerin; preservatives; perfumes; fragrances; aromatizing agents and antimicrobial agents.

28. A method for improving a women's intimate hygiene during the menstrual cycle comprising:
applying a first soap having a pH from about 3.6 to 4.0 to the women's external genital organ during a menstrual period of the menstrual cycle; and
applying a second soap having a pH from about 4.3 to 4.7 to the women's external genital organ during any remaining days of the menstrual cycle.

29. The method of claim 28, wherein the first and second soaps comprise a viscosity regulator, surfactantly pH adjuster, and cosmetically acceptable carrier.

30. The method of claim 28, comprising applying the first soap during days 1 to 5 of the menstrual cycle; and applying the second soap during day 6 to 28 of the menstrual cycle.
